(19) United States
(12) Patent Application Publication
(10) Pub. No.: US 2025/0358709 A1
(43) Pub. Date: Nov. 20, 2025

(54) SESSION CONTROL DEVICE, ACCESS CONTROL DEVICE AND SIGNALING CONTROL METHOD PERFORMED BY DEVICE, AND TERMINAL DEVICE

(71) Applicant: SK TELECOM CO., LTD., Seoul (KR)

(72) Inventors: Hyeon Mo GU, Seoul (KR); Dong Jin LEE, Seoul (KR); Seong Jun LEE, Seoul (KR); Hyun Jun CHOI, Seoul (KR)

(21) Appl. No.: 18/871,869

(22) PCT Filed: Oct. 17, 2022
(86) PCT No.: PCT/KR2022/015747

§ 371 Date: Dec. 5, 2024

(30) Foreign Application Priority Data
Jun. 28, 2022 (KR) 10-2022-0078933

(51) Int. Cl. H04W 40/22; H04W 60/04; H04W 64/00; H04W 76/12

(52) U.S. Cl. CPC H04W 40/22; H04W 60/04; H04W 64/00; H04W 76/12

(57) ABSTRACT

The present invention proposes a wat to implement a specific technique that can make a service request procedure of a UE efficient by reducing signaling occurring in the service request procedure, thereby making overall network performance more efficient in various aspects, such as reducing computing resource consumption for the service request procedure and shortening latency of a UE connection to a data network.

### TECHNICAL FIELD

The disclosure relates to a technology for making a service request procedure of a user equipment (UE) more efficient.

This application claims priority to Korean Patent Application No. 10-2022-0078933, filed Jun. 28, 2022, whose entire disclosures are hereby incorporated by reference.

### BACKGROUND ART

In 5G, a network structure for supporting a UE, a base station (BS) (access), a core, and a server in an end-to-end form is defined.

In 5G, functions of control signaling and data transmission and reception are separated, and a network structure in which an area of the control signaling function (control plane) and an area of the data transmission and reception function (user plane) are separated is defined.

At this time, in 5G, nodes of a control plane (CP) may be defined by an access and mobility management function (AMF) for controlling radio section access of the UE, a policy control function (PCF) for managing/controlling a policy such as UE information and subscribed service information and charging for each UE, a session management function (SMF) for controlling/managing a session for using a data service for each UE, a network exposure function (NEF) for performing a function of sharing information with an external network, a unified data management/authentication function (UDM/AUSF) for managing/controlling a subscriber DB and authentication of the user, a network repository function (NRF) for managing/controlling information on network functions (NFs) within the network, and a charging function (CHF) for processing charging of a subscriber.

Further, in 5G, nodes of a user plane (UP) may be defined as a user plane function (UPF) for transmitting and receiving data between the UE and a server on an external service network (for example, Internet) through a session with the UE, based on the control of (interworking with) the SMF.

In such 5G, the control nodes of the control plane and the data nodes of the user plane may be collectively referred to as network devices (network functions (NFs)).

Meanwhile, the UE interworks with the 5G core in order to access the data network (for example, Internet).

For description thereof, the UE performs a packet data unit (PDU) session generation procedure when traffic transmission is initially needed for the data network.

Thereafter, when there is no traffic transmission and reception of the UE for a predetermined time (for example, about 10 seconds), the RAN releases the control plane/user plane between the UE and the 5G core through an AN release procedure to make radio resources efficient. In this case, the PDU session of the UE is changed to a UP deactivated-state through the AN release procedure.

Thereafter, when traffic transmission for the UE is needed again, the control plane/user plane path between the UE and the 5G core is generated through the service request procedure in which case the PDU session of the UE is changed to the UP-activated state through the service request procedure.

In the statistics of actual commercial networks, the AN release and the service request are very frequently and repeatedly generated. This means that the service request procedure takes up a large portion of the entire network, and if the service request procedure can be made more efficient, the total network performance can be made more efficient.

Considering this, the disclosure proposes a new technical solution that can make the service request procedure of the UE more efficient.

### DISCLOSURE OF INVENTION

### Technical Problem

The technical solution of the disclosure is to realize a new technical method capable of making the service request procedure more efficient by reducing signaling occurring during the service request procedure of the UE.

### Solution to Problem

An apparatus for controlling a session according to an embodiment of the disclosure includes an identification unit configured to identify a user equipment (UE) for activating a path of a user plane (UP) and an information transfer unit configured to transfer specific information related to information storage to an access control device during a UP path activation procedure for the UE so as to allow the access control device to omit some signaling by using the specific information during the UP path activation procedure for the UE.

Specifically, the specific information may be transmitted using a specific message for transmitting a N2 PDU session resource setup request transfer IE including uplink tunnel information of the UP for the UE to the access control device.

Specifically, the specific information may include identification information marking a first identifier for storing information constituting the specific information and the N2 PDU session resource setup request transfer IE including uplink tunnel information of the UP as specific context or a second identifier for deleting specific context pre-stored by previous specific information, and, in case that the first identifier is marked in the identification information, first information indicating a tracking area identity (TAI) in units of predetermined ranges supportable by the UP or second information indicating whether the UP supports all TAIs.

Specifically, the specific message may be a Nsmf_PDUSession_UpdateSMContext Response Message in case that the UP path activation procedure is a UE triggered service request procedure, and may be a Namf_Communication_N1N2MessageTransfer Request Message in case that the UP path activation procedure is a NW triggered service request procedure or a PDU session establishment procedure.

Specifically, the information transfer unit may be configured to determine whether to transmit the specific information, based on the information storage-related possibility pre-received from the access control device.

Specifically, some signaling may be request and response messages which the access control device transmits and receives to and from the apparatus for controlling the session in order to acquire the N2 PDU session resource setup request transfer IE including uplink tunnel information of the UP for the UE.

Specifically, the information transfer unit may be configured to transfer the specific information making the identification information as the second identifier to the access control device in case that a change in the N2 PDU session resource setup request transfer IE including uplink tunnel information of the UP is identified during a UE/RAN triggered PDU session modification procedure or a NW triggered PDU session modification procedure for the UE, so as to allow the access control device to delete specific context pre-stored by previous specific information according to the specific information and perform remaining procedures.

An apparatus for controlling access according to an embodiment of the disclosure includes a context identification unit configured to identify whether pre-stored specific context exists for a user equipment (UE) for activating a path of a user plane (UP), and a controller configured to perform a UP path activation procedure for the UE by using the specific context without some signaling with a session control device in case that the specific context exists.

Specifically, the specific context may be stored by specific information transmitted from the session control device during the UP path activation procedure previously performed for the UE, and may be defined by first information indicating a tracking area identity (TAI) in units of predetermined range supportable by the UP or second information indicating whether the UP supports all TAIs, and a N2 PDU session resource setup request transfer IE including uplink tunnel information of the UP for the UE.

Specifically, during the UP path activation procedure for the UE, the controller may be configured to, in case that it is determined that a location of the UE belongs to a TAI according to the first information or the second information within the specific context, perform remaining procedures by reusing a N2 PDU session resource setup request transfer IE including uplink tunnel information of the UP within the specific context without the said some signaling for acquiring the N2 PDU session resource setup request transfer IE including the uplink tunnel information of the UP for the UE.

Specifically, the controller may be configured to, in case that it is determined that the location of the UE does not belong to the TAI according to the first information in the specific context during a mobility-related procedure for the UE, delete the specific context and perform remaining procedures.

A user equipment (UE) apparatus according to an embodiment of the disclosure includes a request unit configured to transmit a request for activating a path of a user plane (UP) and a controller configured to activate the path of the UP by control of an access control device receiving the request, wherein the request includes a location of the UE apparatus, and the access control device is configured to perform a UP path activation procedure without some signaling during the UP path activation procedure by reusing specific context pre-stored during the UP path activation procedure previously performed for the UE apparatus, based on the location of the UE apparatus, identified in the request.

A method of controlling signaling, performed by a session control device according to an embodiment of the disclosure, includes an identification step of identifying a user equipment (UE) for activating a path of a user plane (UP) and an information transfer step of transmitting specific information related to information storage to an access control device during a UP path activation procedure for the UE, so as to omit some signaling by using the specific information during a subsequent UP path activation procedure for the UE.

Specifically, the specific information may be transmitted using a specific message for transmitting a N2 PDU session resource setup request transfer IE including uplink tunnel information of the UP for the UE to the access control device, and the specific information may include identification information for marking a first identifier storing information constituting the specific information and the N2 PDU session resource setup request transfer IE including uplink tunnel information of the UP for the UE as specific context and a second identifier deleting specific context pre-stored by previous specific information, and first information indicating a tracking area identity (TAI) in units of predetermined ranges supportable by the UP or second information indicating whether the UP supports all TAIs in case that the first identifier is marked in the identified information.

Specifically, the specific information may be transferred to the access control device by using a specific message for transmitting a N2 PDU session resource setup request transfer IE including uplink tunnel information of the UP for the UE, and the specific message may be a Nsmf_PDUSession_UpdateSMContext Response Message in case that the UP path activation procedure for the UE is a UE triggered service request procedure, and may be a Namf_Communication_N1N2MessageTransfer Request Message in case that the UP path activation procedure is a NW triggered service request procedure or a PDU session establishment procedure.

A method of controlling signaling, performed by an access control device according to an embodiment of the disclosure, includes a context identification step of identifying whether pre-stored specific context exists for a user equipment (UE) for activating a path of a user plane (UP) and a control step of performing a UP path activation procedure for the UE by using the specific context without some signaling with a session control device in case that the specific context exists.

### Advantageous Effects of Invention

According to embodiments of the disclosure, a detailed technical configuration capable of making the service request procedure efficient is realized by reducing signaling occurring during the service request procedure of the UE.

Accordingly, the disclosure derives effects of making the total network performance more efficient in various aspects, such as reducing computer resource consumption for the service request procedure and reducing latency for the connection between the UE and the data network.

### BRIEF DESCRIPTION OF DRAWINGS

FIG. 1 illustrates a life cycle of a PDU session separated for each state.

FIGS. 2 and 3 illustrate the call flow in which the existing service request procedure is performed.

FIG. 4 is a block diagram illustrating configurations of a session control device, an access control device, and a UE device according to an embodiment of the disclosure.

FIGS. 5 and 6 are flowcharts illustrating a service request procedure performed by a signaling control method according to an embodiment of the disclosure.

FIGS. 7 and 8 are flowcharts illustrating embodiments in which service request (SR) context is deleted by a signaling control method according to the disclosure.

### BEST MODE FOR CARRYING OUT THE INVENTION

Hereinafter, various embodiments of the disclosure are described with reference to the accompanying drawings.

The disclosure relates to a technology for making a service request procedure of a UE more efficient.

In 5G, a network structure for supporting a UE, a base station (BS) (access), a core, and a server in an end-to-end form is defined.

In 5G, functions of control signaling and data transmission and reception are separated, and a network structure in which an area of the control signaling function (control plane) and an area of the data transmission and reception function (user plane) are separated is defined.

At this time, in 5G, nodes of a control plane (CP) may be defined as an access and mobility management function (AMF) for controlling radio section access of the UE, a policy control function (PCF) for managing/controlling a policy such as UE information and subscribed service information and charging for each UE, a session management function (SMF) for controlling/managing a session for using a data service for each UE, a network exposure function (NEF) for performing a function of sharing information with an external network, a unified data management/authentication function (UDM/AUSF) for managing/controlling a subscriber DB and authentication of the user, a network repository function (NRF) for managing/controlling information on network functions (NFs) within the network, and a charging function (CHF) for processing charging of a subscriber.

Further, in 5G, nodes of a user plane (UP) may be defined as a user plane function (UPF) for transmitting and receiving data between the UE and a server on an external service network (for example, Internet) through a session with the UE, based on the control of (interworking with) the SMF.

In such 5G, the control nodes of the control plane and the data nodes of the user plane may be collectively referred to as network devices (network functions (NFs)).

Meanwhile, the UE interworks with the 5G core in order to access the data network (for example, Internet).

For description thereof, the UE performs a packet data unit (PDU) session generation procedure when traffic transmission is initially needed for the data network.

Thereafter, when there is no traffic transmission and reception of the UE for a predetermined time (for example, about 10 seconds), the RAN releases the control plane/user plane between the UE and the 5G core through an release procedure to make radio resources efficient. In this case, the PDU session of the UE is changed to a UP deactivated-state through the AN release procedure.

Thereafter, when traffic transmission for the UE is needed again, the control plane/user plane path between the UE and the 5G core is generated through the service request procedure in which case the PDU session of the UE is changed to the UP-activated state through the service request procedure.

Last, when data network access is not needed any more (for example, power off), the UE performs a PDU session deletion procedure.

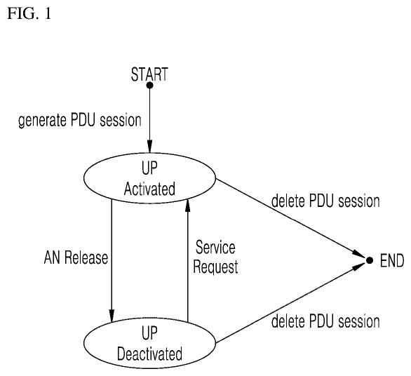

FIG. 1 illustrates a life cycle of a PDU session separated for each state.

Referring to FIG. 1, generation and deletion of the PDU session in the PUD session life cycle occur when there is a specific event such as power on/off, and AN release and service request are frequently repeatedly generated.

In the statistics of actual commercial networks, it is shown that while the proportion of each of the PDU session generation and deletion procedures among the entire procedures is about 0.5%, the proportion of each of the AN release and service request is about 40%.

This means that the service request procedure takes up a large portion of the entire network, and if the service request procedure can be made more efficient, the total network performance can be made more efficient.

Considering this, the disclosure proposes a new technical solution that can make the service request procedure of the UE more efficient.

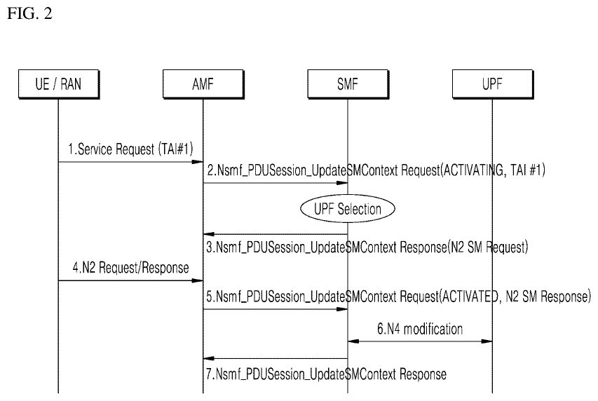

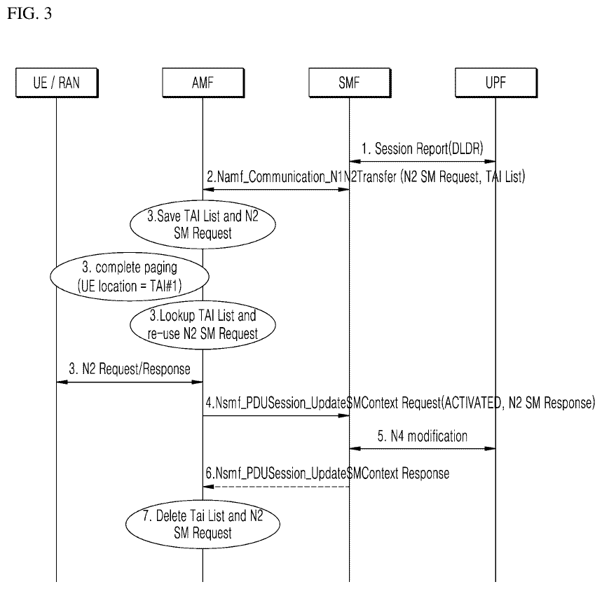

Prior to description of the technical solution proposed in the disclosure, the call flow in which the existing service request procedure is performed is briefly described with reference to FIGS. 2 and 3.

In order to generate (activate) a path of a UP in a state where there is no a user plane (UP) path between the UE and the RAN (UP-deactivated), a UE triggered service request method and a network triggered service request method are used.

FIG. 2 illustrates a UE triggered service request method, and FIG. 3 illustrates a NW triggered service request method.

The UE triggered service request procedure is described below with reference to FIG. 2.
1. When the UE needs to transmit uplink traffic, a service request is transmitted to an AMF (through a RAN). At this time, the request includes UE location information (tracking area identity (TAI)).
2. The AMF selects a UPF supporting the corresponding TAI to the SMF and makes a request for transmitting N2 SM information (tunnel information for receiving uplink).
3. After the SMF selects the UPF, based on the corresponding TAI, the corresponding UPF transfers a N2 SM request including tunnel information for receiving uplink to the AMF.
4. The AMF transmits a N2 request including information received from the SMF to the RAN. Accordingly, a path for transmitting uplink between the UE and the 5G core is generated through the RAN. The RAN transfers a N2 response (tunnel information for receiving downlink) to the AMF.
5. The AMF transfers the information received from the RAN to the SMF.
6. The SMF transmits tunnel information for transmitting downlink to the UPF. Accordingly, a path for transmitting downlink between the UE and the 5G core is generated through the UPF.
7. The SMF transmits an update response to the AMF.

As described above, according to the existing UE triggered service request procedure, the AMF cannot know UPF information supportable for the UE location (for example, TAI #1), and thus has a limit that the AMF always transmits Nsmf_PDUSession_UpdateSMContext_Request to the SMF to make a request for transmitting UPF selection and N2 SM information at step 2.

Meanwhile, the NW triggered service request procedure is described below with reference to FIG. 3.
1. When the UPF receives downlink traffic but is in a UP deactivated state, the UPF transmits a session report (downlink data report (DLDR)) to the SMF.
2. The SMF may transmit a N2 SM request (tunnel information for receiving uplink by the UPF) and a TAI list supportable by the UPF while making a request for paging to the AMF.
3. The AMF stores the received N2 SM request and TAI list. After paging is completed, the AMF identifies whether the UE location (for example, TAI #1) is within the TAI list supportable by the UPF and, when the UE location is within the TAI list, transmits a N2 request to the RAN by using the N2 SM request received at step 2. Accordingly, a path for transmitting uplink between the UE and the 5G core is generated through the RAN. The RAN transfers a N2 response (tunnel information for receiving downlink) to the AMF.
4. The AMF transfers the information received from the RAN to the SMF.
5. The SMF transmits tunnel information for transmitting downlink to the UPF.

Accordingly, a path for transmitting downlink between the UE and the 5G core is generated through the UPF.
6. The SMF transmits an update response to the AMF.
7. The AMF deletes the TAI list and N2 SM request received at step 2.

As described above, according to the existing NW triggered service request procedure, when it is considered that individual TAIs have values from H′000001 to H′FFFFFE and the UPF can support up to about 16.77 million TAIs, there is a limit that the payload required for transmitting the TAI list at step 2 increases, resulting in reduced performance or transmission impossibility.

Further, as described above, according to the existing NW triggered service request procedure, there are limits in that the N2 SM request and the TAI list received at step 2 are valid only in this procedure and cannot be reused and in that it is required to add the SMF configuration when TAIs supportable by the UPF are managed in a list form and a TAI is added due to an increase in a base station.

Accordingly, the disclosure intends to realize a new technical method capable of improving the limits of the existing service request procedure and making the service request procedure more efficient through a detailed configuration for reducing signaling generated during the service request procedure.

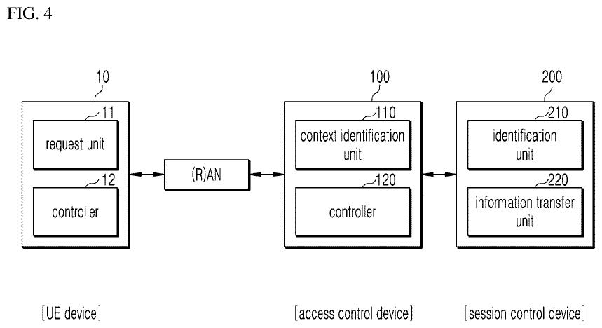

Hereinafter, detailed description for realizing a technical method (hereinafter, referred to as an SR procedure signaling reduction method) proposed in the disclosure is made with reference to FIG. 4.

Specifically, the disclosure proposes a session control device and an access control device as NFs that implement the SR procedure signaling reduction method and proposes a UE device operating through interworking with them, and FIG. 4 illustrates each configuration of the session control device, the access control device, and the UE device.

First, the configuration of a session control device 200 according to an embodiment of the disclosure is described with reference to FIG. 4.

The session control device 200 of the disclosure may be a CU-CP, an SMF, or an S/PGW-C. However, hereinafter, the SMF is described as the session control device 200 for convenience of description.

As illustrated in FIG. 4, the session control device 200 of the disclosure includes an identification unit 210 and an information transfer unit 220.

All or at least some of the configurations of the session control device 200 may be implemented in the form of a hardware module, a software module, or a combination of a hardware module and a software module.

The software modules may be understood as, for example, an instruction executed by a processor configured to control calculations within the session control device 200, and the instruction may have the form installed in a memory within the session control device 200.

As a result, the session control device 200 of the disclosure implements the SR procedure signaling reduction method proposed in the disclosure through the above-described configuration, and hereinafter, each configuration within the session control device 200 for implementing the same is described in more detail.

The identification unit 210 performs a function of identifying the UE 10 for activating a path of a user plane (UP).

At this time, the “UE for activating the path of the UP” identified in connection with the UE triggered service request procedure corresponds to a UE that makes a service request to the AMF (through the RAN) in a UP deactivated state where there is no UP path.

Meanwhile, the “UE for activating the path of the UP” identified in connection with the NW triggered service request procedure corresponds to a UE in a UP-deactivated state where a session report (downlink data report (DLDR)) is transmitted from the UPF.

The information transfer unit 220 performs a function of transferring specific information related to information storage to the access control device 100 during a UP path activation procedure for the UE 10 for activating the path of the UP and thereafter omitting some signaling through the use of the specific information during the UP path activation procedure for the UE 10.

The UP path activation procedure for the UE 10 is a service request procedure.

That is, the information transfer unit 220 may transfer specific information to the access control device 100 (for example, AMF) during the service request procedure of the UE 10 and thereafter omit some signaling through the use of the specific information during the service request procedure of the UE 10.

The specific information is defined to be transmitted using a specific message for transferring an N2 PDU session resource setup request transfer IE including uplink tunnel information of the UP for the UE 10 to the access control device 100 (for example, AMF).

Specifically, the specific message may be a Nsmf_PDUSession_UpdateSMContext response message when the service request procedure of the UP at this time is the UE triggered service request procedure.

That is, the information transfer unit 220 may transfer specific information to the access control device 100 (for example, AMF) by using an additional field within the PDUSession_UpdateSMContext response message for transferring the N2 PDU session resource setup request transfer IE including uplink tunnel information of the UP to the access control device 100 (for example, AMF) during the UE triggered service request procedure according to the service request of the UE 10.

Meanwhile, the specific message may be a Namf_Communication_N1N2MessageTransfer request message when the service request procedure of the UP at this time is the NW triggered service request procedure or a PDU session establishment procedure.

That is, the information transfer unit 220 may transfer specific information to the access control device 100 (for example, AMF) by using an additional field within a Communication_N1N2MessageTransfer request message for transferring the N2 PDU session resource setup request transfer IE including uplink tunnel information of the UP to the access control device 100 (for example, AMF) during the NW triggered service request procedure for the UE 10 according to the report (downlink data report (DLDR)) from the UPF.

Further, in the disclosure, the specific information related to information storage may be defined to include identification information indicating a first identifier for storing information constituting the specific information and the N2 PDU session resource setup request transfer IE including the uplink tunnel information of the UP as specific context or a second identifier for deleting specific context pre-stored by previous specific information, and first information indicating a tracking area identity (TAI) in units of predetermined ranges supportable by the UP or second information indicating whether the UP supports all TAIs in the case where the first identifier is indicated by the identification information.

To this end, the disclosure may newly define “specific information” to be transferred to the access control device 100 (for example, AMF) and “specific context” as information to be stored (cached) by “specific information” received by the access control device 100 (for example, AMF).

In the following description, “specific information” is named “cache-required information”, and “specific context” is named “SR context”.

In a detailed embodiment, the disclosure may newly define the “cache-required information” and the “SR context”, and the “cache-required information” is first defined as shown in [Table 1] below.

TABLE 1

| Attribute name | Data type | P | Cardinality | Description |
|---|---|---|---|---|
| n2CacheRequired | bool | M | 1 | True: case where AMF needs |
| | | | | to cache N2 SM (PDU session |
| | | | | resource setup request transfer) |
| | | | | information and taiRangeList |
| | | | | False: case where AMF needs |
| | | | | to delete cached N2 SM (PDU |
| | | | | session resource setup request |
| | | | | transfer) information and |
| | | | | taiRangeList |
| taiRangeList | array(taiRange) | C | 1 . . . N | taiRangeList exists when |
| | | | | n2CacheRequired is true. |
| | | | | When taiRangeList exists, a |
| | | | | value thereof includes list of |
| | | | | TAI range supportable by UPF. |
| allPLMN | bool | C | 1 | allPLMN exists when |
| | | | | n2CahceRequired is true |
| | | | | When allPLMN exists, a value |
| | | | | thereof means that UPF |
| | | | | supports all TAIs. |
| | | | | Accordingly, N2 SM |
| | | | | information can be reused |
| | | | | regardless of UE location. |

Only one of taiRangeList and allPLMN may be included.

According to an embodiment defined as shown in [Table 1], “specific information” defined in the disclosure, that is, “cache-required information” includes identification information “n2CacheRequired” indicating true as a first identifier and false as a second identifier, and “taiRangeList” as first information and “allPLMN” as second information included when n2CacheRequired is true.

Here, taiRangeList means that a plurality of “taiRange” indicating TAIs in a predetermined range is transmitted in the array form. Detailed content of taiRange may include a PLMN and TacRange.

The taiRange is defined such as TAIs are designated in units of predetermined ranges using values of start to end, and thus if taiRange is designated/registered for each service region, additional work may not be needed according to addition of a new BS.

Therefore, it may be more efficient in term of operation/management than a method using the TAI list that designates individual TAIs one by one according to the existing 3GPP standard (used in the existing NW triggered service request procedure).

Meanwhile, allPLMN means that the UPF supports all TAIs.

According to the definition of [Table 1], “specific content” defined in the disclosure, that is, “SR context” refers to “N2 SM information (PDU session resource setup request transfer=N2 SM request)” and “taiRangeList or allPLMN)” stored (cached) according to reception of n2CacheRequired=true in cached-required information by the access control device 100 (for example, AMF) described below.

When the access control device 100 (for example, AMF) stores (caches) taiRangeList as the SR context and the location of the corresponding UE 10 (for example, TAI #1) is within the stored (cached) taiRangeList during the following service request procedure for the UE 10, some signaling may be omitted during the service request procedure at this time.

Alternatively, when the access control device 100 (for example, AMF) stores (caches) allPLMN as the SR context, some signaling may be omitted during the service request procedure at this time regardless of the location of the corresponding UE 10 (for example, TAI #1) during the following service request procedure for the UE 10.

At this time, some signaling omitted in the service request procedure may be request and response messages which the access control device 100 (for example, AMF) transmits and receives to and from the session control device 200 (for example, SMF) in order to acquire N2 PDU session resource setup request transfer IE including uplink tunnel information of the UP for the UE 10.

That is, the access control device 100 (for example, AMF) may perform the remaining procedures (step 4 of FIG. 2 and thereafter) by reusing the N2 SM information (=N2 SM request) stored (cached) as the SR context without any request/response (steps 2 and 3 of FIG. 2) transmitted and received to and from the session control device 200 (for example, SMF) in order to acquire the N2 PDU session resource setup request transfer IE including the uplink tunnel information of the UP for the UE 10 during the service request procedure for the UE 10.

Meanwhile, in a more detailed embodiment, the information transfer unit 220 may determine whether specific information, that is, cache-required information is transmitted based on possibility related to the information storage pre-received from the access control device 100 (for example, AMF) is possible (hereinafter, whether SR context cache is possible).

To this end, in the disclosure, the access control device 100 (for example, AMF) may transfer information indicating whether the access control device itself can cache the SR context to the session control device 200 (for example, SMF), and the corresponding information may be transmitted using an additional field within the Nsmf_PDUSession_CreateSMContext request or the Nsmf_PDUSession_UpdateSMContext request.

The information transfer unit 220 of the session control device 200 (for example, SMF) may determine whether to also transmit cache-required information by using a message for transmitting the N2 PDU session resource setup request transfer IE to the access control device 100 (for example, AMF) during the (UE triggered or NW UE triggered) service request procedure of the UE 10 that interworks with the corresponding access control device 100 (for example, AMF), based on information indicating whether the SR context pre-received from the access control device 100 (for example, AMF) can be cached.

Meanwhile, in a more detailed embodiment, the information transfer unit 220 may transfer, to the access control device 100 (for example, AMF), specific information (cache-required information) that marks the identification information (n2CacheRequired) as the second identifier (false) when a change in the N2 PDU session resource setup request transfer IE including the uplink tunnel of the UP is identified during a UE/RAN triggered PDU session modification procedure or a NW triggered PDU session modification procedure for the UE 10.

That is, in connection with the uplink tunnel information of the UP for the UE 10, that is, N2 SM information (=N2 PDU session resource setup request transfer IE), information such as QoS information, and N3 tunnel information may be changed.

In the disclosure, the change in the information such as the N2 SM information (=N2 PDU session resource setup request transfer IE) is identified, SR context stored (cached) in the access control device 100 (for example, AMF) is not valid any more, and thus cache-required information indicated by n2CacheRequired=False may be transferred to the access control information 100 (for example, AMF) and a request for deleting the SR context may be made.

The reference by which the session control device 200 (for example, SMF) of the disclosure determines/identifies whether information such as the N2 SM information (=N2 SM request) is changed may include the following changes.
PDU Session Aggregate Maximum Bit Rate
UL NG-U UP TNL Information
QoS Flow Setup Request List
Redundant UL NG-U UP TNL Information

According to reception of n2CacheRequired=False in the transferred cache-required information, the access control device 100 (for example, AMF) may delete the SR context for the UE 10 stored (cached) by the previous cache-required information and perform the UE/RAN triggered PDU session modification procedure that is being performed for the UE 10 or the remaining operations of the NW triggered PDU session modification procedure.

Subsequently, the configuration of the access control device 100 according to an embodiment of the disclosure is described with reference to FIG. 4.

The access control device 100 of the disclosure may be the AMF.

As illustrated in FIG. 4, the access control device 100 of the disclosure includes a context identification unit 110 and a controller 120.

All or at least some of the configurations of the access control device 100 may be implemented in the form of a hardware module, a software module, or a combination of a hardware module and a software module.

The software module may be understood as, for example, an instruction executed by the processor configured to control calculations within the access control device 100, and the instruction may have the form installed in a memory within the access control device 100.

As a result, the access control device 100 of the disclosure implements the SR procedure signaling reduction method proposed in the disclosure through the above-described configurations, and hereinafter, each configuration within the access control device 100 for implementing the same is described in more detail.

The context identification unit 110 performs a function of identifying whether there is pre-stored specific context for the UE for activating a path of a user plane (UP).

The “UE for activating the path of the UP” is a UE performing a (UE triggered or NW triggered) service request procedure in a UP-deactivated state, and the UE 10 is described therefor.

The specific context is SR context stored (cached) by specific information, that is, the “cache-required information” transmitted from the session control device 200 (SMF) of the disclosure during the previously performed service request procedure as described above.

Specifically, the session control device 200 of the disclosure may also transmit cache-required information by using a message for transferring the N2 PDU session resource setup request transfer IE including uplink tunnel information of the UP to the access control device 100 (for example, AMF) during the (UE triggered or NW UE triggered) service request procedure of the UE 10.

When there is cache-required information in a message transmitted from the session control device 200, the access control device 100 (for example, AMF) of the disclosure stores (caches) information by the corresponding cache-required information, and the stored (cached) information corresponds to SR context.

According to an embodiment of the disclosure, in the disclosure, the SR context may be defined as “taiRangeList” that is first information indicating TAI in units of predetermined ranges supportable by the UP or “allPLMN” that is second information indicating whether all TAIs are supported by the UP, and “N2 SM information (=N2 PDU session resource setup request transfer IE=N2 SM request)” that is the N2 PDU session resource setup request transfer IE including the uplink tunnel information of the UP for the UE 10.

That is, when receiving n2CacheRequired=true in the cache-required information, the access control device 100 (for example, AMF) of the disclosure may store (cache) “N2 SM information (=N2 SM request)” and “taiRangeList (or allPLMN)” as the SR context according thereto.

For the UE 10 performing the (UE triggered or NW triggered) service request procedure, the context identification unit 110 identifies whether there is SR context pre-stored (pre-cached) by the disclosure.

When there is SR context pre-stored (pre-cached) by the disclosure for the UE 10, the controller 120 performs a function of proceeding the UP path activation procedure (service request procedure) for the UE 10 by using the corresponding SR context without some signaling with the session control device 200 (for example, SMF).

Specifically, during the service request procedure for the UE 10, the controller 120 determines whether the location (for example, TAI #1) of the UE 10 belongs to the TAI according to “taiRangeList” as first information and “allPLMN” as second information within the pre=stored (pre-cached) SR context.

For example, when taiRangeList is pre-stored (pre-cached) as the SR context, the controller 120 determines whether the location (for example, TAI #1) of the corresponding UE 10 belongs to the pre-stored (pre-cached) taiRangeList.

When allPLMN is stored (cached) as the SR context, the controller 120 determines that the location belongs to allPLMN regardless of the location (for example, TAI #1) of the corresponding UE 10.

Accordingly, when it is determined that the location (for example, TAI #1) of the corresponding UE 10 belongs to taiRangeList (or allPLMN) within the SR context, the controller 120 may perform the remaining procedures by reusing the N2 PDU session resource setup request transfer IE including the uplink tunnel information of the UP within the SR context without some signaling for acquiring the N2 PDU session resource setup request transfer IE including the uplink tunnel information of the UP during the service request procedure at this time.

For example, when it is determined that there is SR context pre-stored (pre-cached) for the corresponding UE 10 during the service request procedure for the UE 10 and the location (for example, TAI #1) of the corresponding UE 10 belongs to taiRangeList (or allPLMN) within the SR context, the access control device 100 (for example, AMF) of the disclosure may perform the remaining procedures (step 4 of FIG. 2 and thereafter) by reusing N2 SM information (=N2 SM request) stored (cached) as the SR context without any request/response (steps 2 and 3 of FIG. 2) transmitted and received to and from the session control device 200 (for example, SMF) to acquire the N2 PDU session resource setup request transfer IE including the uplink tunnel information of the UP for the UE 10.

Meanwhile, in a more detailed embodiment, when it is determined that the location (for example, TAI) of the UE 10 does not belong to the TAI according to the first information, that is, taiRangeList within the SR context during mobility-related procedure for the UE 10, the controller 120 may delete the corresponding SR context and perform the remaining procedures.

That is, the location (for example, TAI) may be changed according to movement (for example, handover) of the UE 10, and when it is determined that the location (for example, TAI) of the UE 10 does not belong to the TAI according to taiRangeList within the SR context due thereto in the disclosure, the pre-stored (pre-cached) SR context is not valid any more, and thus the corresponding SR context is deleted.

Then the access control device 100 (for example, AMF) in the disclosure may delete the SR context for the UE 10 pre-stored (pre-cached) by the previous cache-required information and perform the remaining procedures for the mobility-related procedure that is being performed for the UE 10.

Subsequently, the configuration of the UE device 10 according to an embodiment of the disclosure is described with reference to FIG. 4.

The UE device 10 of the disclosure includes a request unit 11 and a controller 12.

All or at least some of the configurations of the UE device 10 may be implemented in the form of a hardware module, a software module, or a combination of a hardware module and a software module.

The software module may be understood as, for example, an instruction executed by a processor configured to control calculations within the UE device 10, and the instruction may have the form installed in a memory within the UE device 10.

As a result, the UE device 10 of the disclosure supports the SR procedure signaling reduction method proposed in the disclosure through the above-described configurations, and hereinafter, each configuration within the UE device 10 for implementing the same is described in more detail.

The request unit 11 performs a function of transmitting a request for activating a path of a UP.

Activation of the path of the UP refers to a UP-activated state, and the request for activating the path of the UE refers to a service request.

That is, when the UE device 10 needs to transmit uplink traffic in the UP-deactivated state, the request unit 11 may transfer a request for UP activation, that is, a service request to the AMF (through the RAN).

The controller 12 may activate the path of the UP according to the control of the access control device 100 (for example, AMF) receiving the request, that is, the service request, and the UE device 10 may become the UP-activated state.

The request, that is, the service request transmitted by the request unit 11 includes the location (for example, TAI #1) of the UE device 10.

The access control device 100 (for example, AMF) receiving the service request may perform the UP service request procedure at this time without some signaling by reusing specific context (SR context) pre-stored during the UP service request procedure previously performed for the UE device 10, based on the location (for example, TAI #1) of the UE device 10 identified in the service request.

That is, when the access control device 100 (for example, AMF) stores (caches) taiRangeList as the SR context and the location (for example, TAI #1) of the UE device 10 belongs to the stored (cached) taiRangeList during the service request procedure for the UE 10, the service request procedure at this time may be performed without some signaling.

As described above, according to the session control device and the access control device of the disclosure, the signaling control method performed by the devices, and the UE device, a detailed technical configuration capable of making the service request procedure efficient may be implemented by reducing signaling made during the UE service request procedure.

Accordingly, the disclosure may derive an effect of making the total network performance more efficient in various aspects such as reducing computing resource consumption for the service request procedure and reducing latency for the connection between the UE and the data network by realizing a new technical method capable of making the service request procedure of the UE efficient.

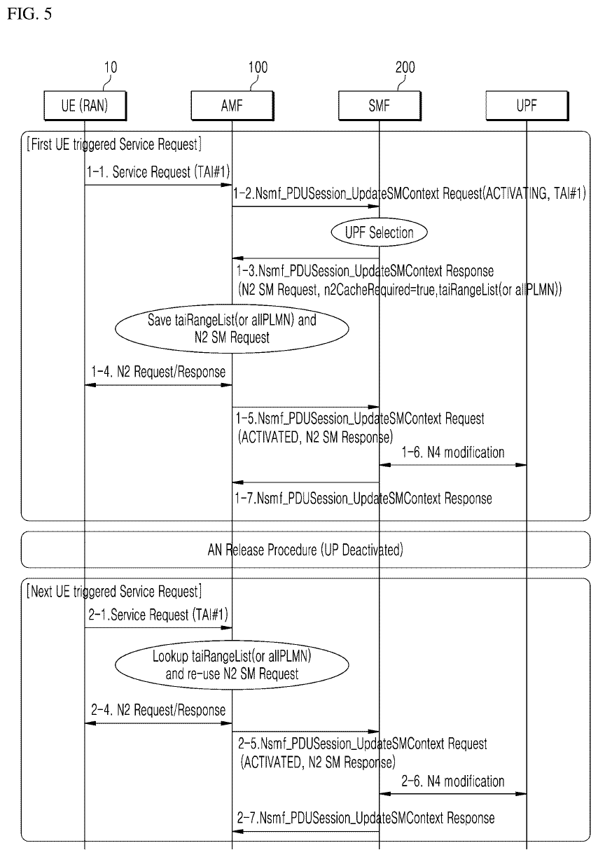

Hereinafter, embodiments for implementing the SR procedure signaling reduction method performed by the disclosure are described with reference to FIGS. 5 to 8.

Hereinafter, embodiments for implementing the SR procedure signaling reduction method performed by the disclosure are described with reference to FIGS. 5 to 8.

First, FIG. 5 illustrates a service request procedure, particularly, a UE triggered service request procedure performed by the signaling control method according to an embodiment of the disclosure.

An initial service request procedure (first UE triggered service request) for the UE 10 is described below with reference to FIG. 5.
1-1. When the UE 10 needs to transmit uplink traffic, a service request is transmitted to the AMF 100 (through the RAN). The request includes the location (for example, TAI #1) of the UE 10.
1-2. The AMF 100 selects a UPF supporting the corresponding TAI (for example, TAI #1) to the SMF 200 and makes a request for transmitting N2 SM information (tunnel information for receiving uplink).
1-3. 1 After selecting the UPF, based on the corresponding TAI (for example, TAI #1), the SMF 200 transmits both the N2 SM request including tunnel information for receiving the uplink by the corresponding UPF and taiRangeList (or allPLMN) and n2CahceRequired=true supportable by the selected UPF as “cache-required information” to the AMF 100.
1-4. The AMF 100 stores the N2 SM request and taiRangeList (or allPLMN) in the cache as “SR context” by the “cache-required information” and transmits the N2 request including information received from the SMF 200 to the RAN. Accordingly, a path for transmitting uplink between the UE 10 and the 5G core is generated through the RAN. The RAN transfers a N2 response (tunnel information for receiving downlink) to the AMF 100.
1-5. The AMF 100 transfers information received from the RAN to the SMF 200.
1-6. The SMF 200 transmits tunnel information for transmitting downlink to the UPF. Accordingly, a path for transmitting downlink between the UE 10 and the 5G core is generated through the UPF.
1-7. The SMF 200 transmits an update response to the AMF 100.

As described above, in the disclosure, during the initial service request procedure (first UE triggered service request), the SMF 200 transfers the “cache-required information” to the AMF 100 to allow the AMF 100 to store the “SR context”, and thus the SR context may be used (reused) to omit some signaling during the following service request procedure for the UE 10.

That is, as illustrated in FIG. 5, the case where the service request procedure (next UE triggered service request) is performed for the UE 10 in the UP-deactivated state by the AN release procedure is described.
2-1. When the UE 10 needs to transmit uplink traffic, a service request is transmitted to the AMF 100 (through the RAN). The request includes the location (for example, TAI #1) of the UE 10. The TAI may be changed according to the location of the UE 10.
2-4. The AMF 100 identifies taiRangeList stored in the cache and, when the location (for example, TAI #1) of the UE 10 is within taiRangeList, reuses the N2 SM request (reuses the N2 SM request without identifying the TAI in the case of allPLMN). That is, the AMF 100 may transmit N2 SM request information to the RAN without steps 1-2 and 1-3 described above. Accordingly, a path for transmitting uplink between the UE 10 and the 5G core is generated through the RAN. The RAN transfers a N2 response (tunnel information for receiving downlink) to the AMF 100.
2-5. The AMF 100 transfers information received from the RAN to the SMF 200.
2-6. The SMF 200 transmits tunnel information for transmitting downlink to the UPF. Accordingly, a path for transmitting downlink between the UE 10 and the 5G core is generated through the UPF.
2-7. The SMF 200 transmits an update response to the AMF 100.

Conventionally, since the AMF cannot know UPF information supportable for the location (for example, TAI #1) of the UE 10 whenever the service request procedure is performed, the AMF should select a UPF and make a request for transmitting N2 SM information by always transmitting Nsmf_PDUSession_UpdateSMContext_Request to the SMF.

However, as described above, in the disclosure, it is possible to reduce transaction between the AMF 100 and the SMF 200 by using (reusing) the “SR context” pre-stored in the AMF 100 by “cache-required information” transmitted by the SMF 200 during the previous service request procedure and thus omitting some signaling during the following service request procedure for the UE 10.

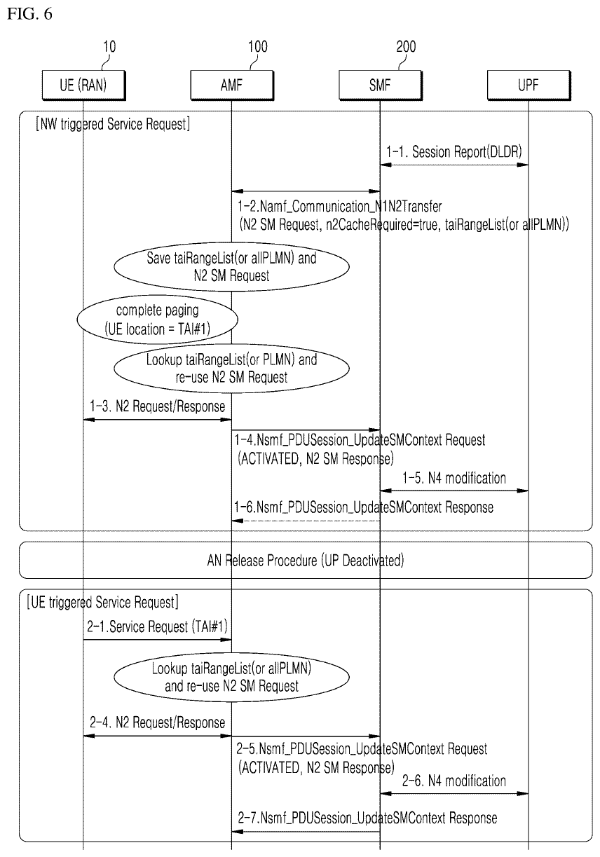

FIG. 6 illustrates a service request procedure, particularly, a NW triggered service request procedure performed by the signaling control method according to an embodiment of the disclosure.

The following description is made with reference to FIG. 6.
1-1. When the UPF receives downlink traffic but is in a UP-deactivated state, the UPF transmits a session report (downlink data report (DLDR)) to the SMF 200.
1-2. The SMF 200 transmits the N2 SM request (tunnel information to receive uplink by the UPF) while making a request for paging to the AMF 100. At this time, the SMF 200 also transmit taiRangeList (or allPLMN) and n2CahceRequired=true supportable by the UPF to the AMF 100 as “cache-required information”.
1-3. The AMF 100 stores the N2 SM request and taiRangeList (or allPLMN) in the cache as the “SR context” by the “cache-required information”. After paging is completed, the AMF 100 identifies whether the location (for example, TAI #1) of the UE 10 is within taiRangeList supportable by the UPF and, when the location is within taiRangeList, transmits the N2 request to the RAN by reusing N2 SM information received at step 1-2 (reuses the N2 SM request without identifying the TAI in the case of allPLMN). Accordingly, a path for transmitting uplink between the UE 10 and the 5G core is generated through the RAN. The RAN transfers the N2 response (tunnel information for receiving downlink) to the AMF.
1-4. The AMF 100 transfers information received from the RAN to the SMF 200.
1-5. The SMF 200 transmits tunnel information for transmitting downlink to the UPF. Accordingly, a path for transmitting downlink between the UE 10 and the 5G core is generated through the UPF.
1-6. The SMF 200 transmits an update response to the AMF 100.

As described above, in the disclosure, during the NW triggered service request, the SMF 200 transfers the “cache-required information” to the AMF 100 to allow the AMF 100 to store the “SR context”, and thus the SR context may be used (reused) to omit some signaling during the following service request procedure for the UE 10.

That is, as illustrated in FIG. 6, the case where the UE triggered service request is performed for the UE 10 in the UP-deactivated state by the AN release procedure is described.
2-1. When the UE 10 needs to transmit uplink traffic, a service request is transmitted to the AMF 100 (through the RAN). The request includes the location (for example, TAI #1) of the UE 10. The TAI may be changed according to the location of the UE 10.
2-4. The AMF 100 identifies taiRangeList stored in the cache and, when the location (for example, TAI #1) of the UE 10 is within taiRangeList, reuses the N2 SM request (reuses the N2 SM request without identifying the TAI in the case of allPLMN). That is, the AMF 100 may transmit N2 SM request information to the RAN without steps 1-2 and 1-3 of FIG. 5. Accordingly, a path for transmitting uplink between the UE 10 and the 5G core is generated through the RAN. The RAN transfers a N2 response (tunnel information for receiving downlink) to the AMF 100.
2-5. The AMF 100 transfers information received from the RAN to the SMF 200.
2-6. The SMF 200 transmits tunnel information for transmitting downlink to the UPF. Accordingly, a path for transmitting downlink between the UE 10 and the 5G core is generated through the UPF.
2-7. The SMF 200 transmits an update response to the AMF 100.

As described above, in the disclosure, it is possible to reduce transaction between the AMF 100 and the SMF 200 by using (reusing) the “SR context” pre-stored in the AMF 100 by “cache-required information” transmitted by the SMF 200 during the previous service request procedure and thus omitting some signaling during the following service request procedure for the UE 10.

Particularly, according to the NW triggered service request procedure of the disclosure, instead of using the TAI list including individual TAIs, the SMF 200 transfers taiRangeList to the AMF 100 and the AMF 100 uses (reuses) taiRangeList, so that there is an effect of omitting/reducing signaling during the service request procedure.

Further, according to the NW triggered service request procedure of the disclosure, when TAIs are added due to a base station increase through the use of taiRangeList unlike the conventional case where individual TAIs are listed and used, it is possible to make the service request procedure efficient and also make the total network performance more efficient in various aspects due to unnecessity of SMF configuration addition and possibility of the reuse of the N2 SM request.

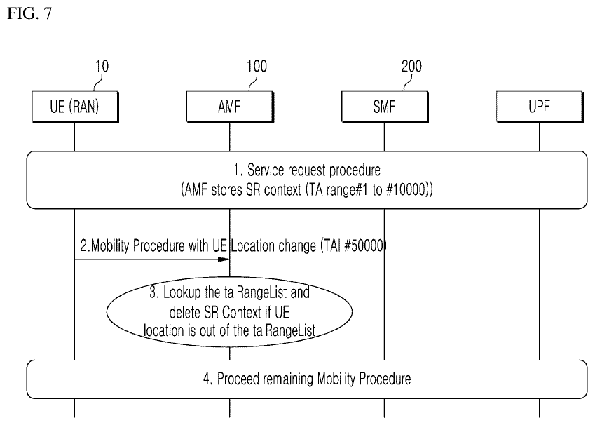

FIG. 7 illustrates the flow of an embodiment in which SR context is deleted by the signaling control method, particularly, an embodiment in which the AMF actively performs deletion according to the disclosure.

Functions of the disclosure deleted when SR context stored by the AMF 100 is not valid any more are described below with reference to FIG. 7.
1. It is premised that the service request procedure according to the SR procedure signaling reduction method of the disclosure is performed and the AMF 100 pre-store SR context after receiving cache-required information from the SMF 200.
2. The UE/RAN may perform a mobility-related procedure (for example, handover) with the AMF 100 according to movement of the UE 10.
3. The AMF 100 identifies whether the location of the UE 10 received during the mobility-related procedure is included in taiRangeList in the SR context and, when the location is not included therein, deletes the SR context. When the location is included in taiRangeList, the SR context is not deleted.
4. Thereafter, the AMF 100 performs the remaining mobility-related procedure in the same way.

As described above, since the AMF 100 has not SR context during the initial service request after the SR context is deleted, there is no signaling reduction effect by the disclosure, but the signaling reduction effect by the disclosure occurs from the time the following service request procedure is performed.

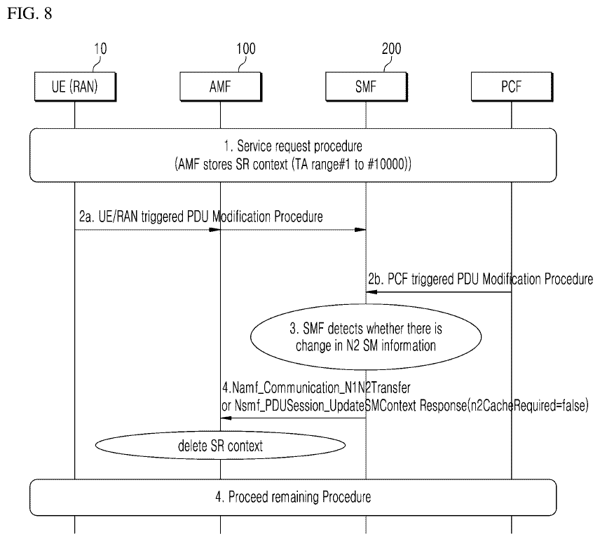

FIG. 8 illustrates the flow of an embodiment in which SR context is deleted by the signaling control method, particularly, an embodiment in which the deletion is performed by the SMF according to the disclosure.

Functions of the disclosure deleted when SR context stored by the AMF 100 is not valid any more are described below with reference to FIG. 8.
1. It is premised that the service request procedure according to the SR procedure signaling reduction method of the disclosure is performed and the AMF 100 pre-stores SR context after receiving cache-required information from the SMF 200.
2a. The UE/RAN performs a modification procedure (UE/RAN triggered PDU session modification procedure) when a change in a PDU session is needed. In this case, a change in N2 SM information such as a QoS change may be made.
2b. The PCF performs a modification procedure (NW triggered PDU session modification procedure) when a change in a PDU session is needed. In this case, a change in N2 SM information such as a QoS change may be made.
3. The SMF 200 may detect whether N2 SM information is changed by step 2a or 2b.
4. When the change is detected, the SMF 200 transfers cache-required information marked as n2CacheRequired=False to the AMF 100 in order to delete the SR context stored in the AMF 100.
5. The AMF 100 identifies n2CacheRequired=false in the received cache-required information and deletes the pre-stored SR context.

As described above, since the AMF 100 has not SR context during the initial service request after the SR context is deleted, there is no signaling reduction effect by the disclosure, but the signaling reduction effect by the disclosure occurs from the time the following service request procedure is performed.

As described above, according to the data transmission method of the disclosure, it is possible to prevent additional delay of data transmission and also minimize data transmission delay by avoiding induction/initiation of the network triggered service request procedure additionally performed in a “situation where signaling processing is slower than a data transmission rate” of downlink data for the UE transferred/introduced to the UPF during signaling of a CP path (re) generation procedure.

The signal controlling method and the data processing method according to an embodiment of the present disclosure may be implemented in a form of program command that may be configured to be executed through various computer means and recorded on a computer readable medium. The computer readable medium may include program commands, data files, data structures, etc. alone or in combination. Program commands recorded on the medium may be specially designed and configured for the present disclosure or known and usable to those skilled in computer software. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program commands, such as ROM, RAM, flash memory, and the like. Examples of program commands include high-level language codes that may be executed by a computer using an interpreter, as well as machine language codes produced by a compiler. The aforementioned hardware device may be configured to function as one or more software modules to perform the operations of the present disclosure, and vice versa.

Although the present disclosure has been described in detail with reference to preferred embodiments, the present disclosure is not limited to the above-described embodiments, and the technical idea of the present disclosure extends to the extent that any person with ordinary knowledge in the technical field to which the present disclosure belongs may make various changes or modifications without departing from the gist of the present disclosure claimed in the following claims.

1. An apparatus for controlling a session, the apparatus comprising:
an identification unit configured to identify a user equipment (UE) for activating a path of a user plane (UP); and
an information transfer unit configured to transfer specific information related to information storage to an access control device during a UP path activation procedure for the UE so as to allow the access control device to omit some signaling by using the specific information during the UP path activation procedure for the UE.

2. The apparatus of claim 1, wherein the specific information is transmitted using a specific message for transmitting a N2 PDU session resource setup request transfer IE comprising uplink tunnel information of the UP for the UE to the access control device.

3. The apparatus of claim 2, wherein the specific information comprises:
identification information marking a first identifier for storing information constituting the specific information and the N2 PDU session resource setup request transfer IE as specific context or a second identifier for deleting specific context pre-stored by previous specific information; and in case that the first identifier is marked in the identification information, first information indicating a tracking area identity (TAI) in units of predetermined ranges supportable by the UP or second information indicating whether the UP supports all TAIs.

4. The apparatus of claim 2, wherein the specific message is a Nsmf_PDUSession_UpdateSMContext Response Message in case that the UP path activation procedure is a UE triggered service request procedure, and is a Namf_Communication_N1N2MessageTransfer Request Message in case that the UP path activation procedure is a NW triggered service request procedure or a PDU session establishment procedure.

5. The apparatus of claim 1, wherein the information transfer unit is configured to determine whether to transmit the specific information, based on the information storage-related possibility pre-received from the access control device.

6. The apparatus of claim 2, wherein the some signaling is request and response messages which the access control device transmits and receives to and from the apparatus for controlling the session in order to acquire the N2 PDU session resource setup request transfer IE for the UE.

7. The apparatus of claim 2, wherein the information transfer unit is configured to transfer the specific information making the identification information as the second identifier to the access control device in case that a change in the N2 PDU session resource setup request transfer IE is identified during a UE/RAN triggered PDU session modification procedure or a NW triggered PDU session modification procedure for the UE, so as to allow the access control device to delete specific context pre-stored by previous specific information according to the specific information and perform remaining procedures.

8. An apparatus for controlling access, the apparatus comprising:
a context identification unit configured to identify whether pre-stored specific context exists for a user equipment (UE) for activating a path of a user plane (UP); and
a controller configured to perform a UP path activation procedure for the UE by using the specific context without some signaling with a session control device in case that the specific context exists.

9. The apparatus of claim 8, wherein the specific context is stored by specific information transmitted from the session control device during the UP path activation procedure previously performed for the UE, and is defined by first information indicating a tracking area identity (TAI) in units of predetermined range supportable by the UP or second information indicating whether the UP supports all TAIs, and a N2 PDU session resource setup request transfer IE comprising uplink tunnel information of the UP for the UE.

10. The apparatus of claim 9, wherein the controller is configured to transfer whether the apparatus for controlling access is able to store specific context to the session control device, so as to allow the session control device to determine whether to transmit the specific information.

11. The apparatus of claim 8, wherein the controller is configured to, in case that it is determined that a location of the UE belongs to a TAI according to the first information or the second information within the specific context during the UP path activation procedure for the UE, perform remaining procedures by reusing a N2 PDU session resource setup request transfer IE comprising uplink tunnel information of the UP within the specific context without the some signaling for acquiring the N2 PDU session resource setup request transfer IE comprising the uplink tunnel information of the UP for the UE.

12. The apparatus of claim 8, wherein the controller is configured to, in case that it is determined that the location of the UE does not belong to the TAI according to the first information in the specific context during a mobility-related procedure for the UE, delete the specific context and perform remaining procedures.

13. A user equipment (UE) apparatus comprising:
a request unit configured to transmit a request for activating a path of a user plane (UP); and
a controller configured to activate the path of the UP by control of an access control device receiving the request,
wherein the request comprises a location of the UE apparatus, and
wherein the access control device is configured to perform a UP path activation procedure without some signaling during the UP path activation procedure by reusing specific context pre-stored during the UP path activation procedure previously performed for the UE apparatus, based on the location of the UE apparatus, identified in the request.

14. A method of controlling signaling, performed by a session control device, the method comprising:
an identification step of identifying a user equipment (UE) for activating a path of a user plane (UP); and
an information transfer step of transmitting specific information related to information storage to an access control device during a UP path activation procedure for the UE, so as to omit some signaling by using the specific information during a subsequent UP path activation procedure for the UE.

15. A method of controlling signaling, performed by an access control device, the method comprising:
a context identification step of identifying whether pre-stored specific context exists for a user equipment (UE) for activating a path of a user plane (UP); and
a control step of performing a UP path activation procedure for the UE by using the specific context without some signaling with a session control device in case that the specific context exists.
